(19) United States
(12) Patent Application Publication
(10) Pub. No.: US 2007/0017195 A1
(43) Pub. Date: Jan. 25, 2007

(54) Air filtration media comprising metal-doped precipitated silica materials

(76) Inventors: Michael C. Withiam, Landenberg, PA (US); Fitzgerald A. Sinclair, Bear, DE (US)

Correspondence Address: Carlos Nieves, Esq.;J. M. Huber Corporation, 333 Thornall Street, Edison, NJ, 08837, US

(21) Appl. No.: 11/186,488

(22) Filed: Jul. 21, 2005

(51) Int. Cl. B01D 46/00

(52) U.S. Cl. 55/522

(57) ABSTRACT

The present invention relates generally to an environmental control unit for use in air handling systems that provides highly effective filtration of noxious gases (such as ammonia). Such a filtration system utilizes novel metal-doped precipitated silica materials to trap and remove such undesirable gases from an enclosed environment. Such silicas exhibit specific porosity requirements and density measurements. Furthermore, in order for proper metal doping to take effect, such precipitated silicas must be treated while in a wet state. The combination of these particular properties and metal dopant permits highly effective noxious gas filtration such that uptake and breakthrough results are attained, particularly in comparison with prior precipitated silica filtration products. Methods of using and specific filter apparatuses are also encompassed within this invention.

### FIELD OF THE INVENTION

The present invention relates generally to an environmental control for use in air handling systems that provides highly effective filtration of noxious gases (such as ammonia). Such a filtration system utilizes novel metal-doped precipitated silicas to trap and remove such undesirable gases from an enclosed environment. Such silicas exhibit specific porosity requirements and density measurements. Furthermore, in order for most effective metal doping to take effect, such precipitated silica materials are preferably treated while in a wet state. The combination of these particular properties and metal dopant permits highly effective noxious gas filtration such that excellent uptake and breakthrough results are attained, particularly in comparison with prior media filtration products. Methods of using and specific filter apparatuses are also encompassed within this invention.

### BACKGROUND OF THE INVENTION

There is an ever-increasing need for air handling systems that include air filtration systems that can be deployed to protect an enclosure against noxious airborne agents released in the vicinity of the enclosure. Every year there are numerous incidents of noxious fumes entering buildings and causing illness and disruptions due to accidents or other reasons. There also currently exists heightened awareness of toxic airborne agents being released as part of possible terrorist acts. In addition, military personnel in combat areas may need protection from enemy releases of airborne noxious agents both inside and outside enclosures. Whether a civilian or military setting, a typical air filtration system is generally ineffective against most noxious gases and agents. For example, standard dust filters, such as cardboard framed fiberglass matt filters, exhibit very low propensity for removing micro-sized particles and gases. Commercially available electrostatic fiber filters have higher efficiencies than standard dust filters and can remove pollens and other small solid particulates, but they can not intercept and remove gases. HEPA (“High-Efficiency Particulate Air”) filters are known that are used for high-efficiency filtration of airborne dispersions of ultra fine solid and liquid particulates such as dust and pollen, radioactive particle contaminants, and aerosols. However, where the threat is a gaseous chemical compound or a gaseous particle of extremely small size (i.e., <0.001 microns), the conventional commercially-available HEPA filters cannot intercept and control those types of airborne agents.

The most commonly found filter technology used to remove gaseous substances and materials from an airflow is based on activated carbon. Such gas filtration has been previously implemented in certain applications, such as in gas masks or in industrial processes, by using filter beds of activated impregnated carbons or other sorbents for ultra-high-efficiency filtration of super toxic chemical vapors and gases from an air or gas stream passed through the filter. Commercial filters of this sort generally include activated carbon loaded nonwovens, in which the activated carbon is bonded to a nonwoven fiber mat. Carbon filters used for protection against toxic chemicals are typically designed to maintain an efficiency of at least 99.999% removal of airborne particulates. An activated carbon filter typically functions by removing molecules from an air stream by adsorption in which molecules are entrapped in pores of the carbon granules.

Activated carbons are useful in respirators, collective filters and other applications, and often involved the use of special impregnates to remove gases that would not otherwise be removed through the use of unimpregnated activated carbons. These impregnated activated carbon adsorption for removal of toxic gases and/or vapors have been known and used for many years. The prior art formulations often contain copper, chromium and silver impregnated on an activated carbon. These adsorbents are effective in removing a large number of toxic materials, such as cyanide-based gases and vapors.

In addition to a number of other inorganic materials, which have been impregnated on activated carbon, various organic impregnants have been found useful in military applications for the removal of cyanogen chloride. Examples of these include triethylenediamine (TEDA) and pyridine-4-carboxylic acid.

Various types of high-efficiency filter systems, both commercial and military systems, have been proposed for building protection using copper-silver-zinc-molybdenum-triethylenediamine impregnated carbon for filtering a broad range of toxic chemical vapors and gases. However, such carbon-based filters have proven ineffective for other gases, such as, ammonia, ethylene oxide, formaldehyde, and carbon disulfide. As these other gases are quite prominent in industry and effectively harmful to humans when present in certain amounts (particularly within enclosed spaces), and, to date, other filter devices have proven unsuitable for environmental treatment and/or removal, there exists a definite need for a filter mechanism to remedy these deficiencies. Furthermore, such a specific type of filter medium has proven ineffective to requisite levels of gas removal when the relative humidity of the target environment is too high. To date, no proper filtration system having a relatively small amount of filter medium present has been provided that effectively removes such gases, particularly ammonia, for long durations of time with an uptake and breakthrough that correlates to an acceptable efficiency level and thus proper performance at a suitable cost, and, additionally, that exhibits effective noxious gas removal at relative humidity levels of greater than 50%.

It has been realized that silica-based compositions permit excellent gas filter media. However, there has been little provided within the pertinent prior art that concerns the ability to provide uptake and breakthrough levels by such filter media on a permanent basis and at levels that are acceptable for large-scale usage. Uptake basically is a measure of the ability of the filter medium to capture a certain volume of the subject gas; breakthrough is an indication of the saturation point for the filter medium in terms of capture. Thus, it is highly desirable to find a proper filter medium that exhibits a high uptake (and thus quick capture of large amounts of noxious gases) and long breakthrough times (and thus, coupled with uptake, the ability to not only effectuate quick capture but also extensive lengths of time to reach saturation). The standard filters in use today are limited for noxious gases, such as ammonia, to slow uptake and relatively quick breakthrough times. There is a need to develop a new filter medium that reduces uptake and increases breakthrough and does so using a more economical silica substrate.

The closest art concerning the removal of gases such as ammonia utilizing a potential silica-based compound doped with a metal is taught within WO 00/40324 to Kemira Agro Oy. Such a system, however, is primarily concerned with providing a filter media that permits regeneration of the collected gases, presumably for further utilization, rather than permanent removal from the atmosphere. Such an ability to easily regenerate (i.e., permit release of captured gases) such toxic gases through increases of temperature or changes in pressure unfortunately presents a risk to the subject environment. To the contrary, an advantage of a system as now proposed is to provide effective long-duration breakthrough (thus indicating thorough and effective removal of unwanted gases in substantially their entirety from a subject space over time, as well as thorough and effective uptake of substantially all such gases as indicated by an uptake measurement. The Kemira reference also is concerned specifically with providing a dry mixture of silica and metal (in particular copper I salts, ultimately), which, as noted within the reference, provides the effective uptake and regenerative capacity sought rather than permanent and effective gas (such as ammonia) removal from the subject environment. The details of the inventive filter media are discussed in greater depth below.

### BRIEF DESCRIPTION OF THE INVENTION

According to one aspect of this invention, a filter medium comprising multivalent metal-doped precipitated silica materials, wherein said materials exhibit a BET surface area of between about 30 and 350 m²/g; a pore volume of greater than 0.25 cc/g to 2.0 cc/g as measured by nitrogen porosimetry; a mean pore diameter of greater than about 100 to 300 Å; and wherein the multivalent metal doped on and within said precipitated silica materials is present in an amount of from 5 to 25% by weight of the total amount of the precipitated silica materials. Preferably, said multivalent metal is present in an amount of from about 8 to about 20%.

According to another aspect of the invention, a multivalent metal-doped precipitated silica filter medium that exhibits a breakthrough measurement for an ammonia gas/air composition of at least 50 minutes a) when present as a filter bed of 1 cm in height within a flask of a diameter of 4.1 cm, b) when exposed to a constant ammonia gas concentration of 1000 mg/m³ ammonia gas at ambient temperature and pressure, and c) when exposed simultaneously to a relative humidity of at least 15%; and wherein said filter medium, after breakthrough concentration of 35 mg/m³ is reached, does not exhibit any ammonia gas elution in excess of said breakthrough concentration. Preferably, the breakthrough time is at least 100 minutes. Furthermore, another aspect of this invention concerns multivalent metal-doped precipitated silica materials that exhibit a breakthrough time of at least 50 minutes when exposed to the same conditions as listed above and within the same test protocol, except that the relative humidity is 80%. Preferably, the breakthrough time for such a high relative humidity exposure test example is at least 100 minutes, as well.

According to still another aspect of the invention, a method of producing metal-doped precipitated silica particles is provided, said method comprising the sequential steps of:
a) providing a precipitated silica material;
b) wet reacting said precipitated silica material with at least one multivalent metal salt to produce metal-doped precipitated silica material; and
c) drying said multivalent metal-doped precipitated silica materials.

Alternatively, step “a” may include a production step for generating said precipitated silica materials.

One distinct advantage of this invention is the provision of a filter medium that exhibits highly effective ammonia uptake and breakthrough properties when present in a relatively low amount and under a pressure typical of an enclosed space and over a wide range of relative humidity. Among other advantages of this invention is the provision of a filter system for utilization within an enclosed space that exhibits a steady and effective uptake and breakthrough result for ammonia gas and that removes such noxious gases from an enclosed space at a suitable rate for reduction in human exposure below damage levels. Yet another advantage is the ability of this invention to irreversibly prevent release of noxious gases once adsorbed, under normal conditions. Additionally, precipitated silica materials are more cost effective than other absorbent alternatives.

Also, said invention encompasses a filter system wherein at least 15% by weight of such a filter medium has been introduced therein. Furthermore, the production of such metal-doped precipitated silica particles, wherein the reaction of the metal salt is preferably performed while the precipitated silica particle is in a wet state has been found to be very important in providing the most efficient and thus best manner of incorporating such metal species within the micropores of the subject silica materials. As such, it was determined that such a wet silica doping step was necessary to provide the most efficient filter medium and overall filter systems for such noxious gas (such as, as one example, ammonia).

### DETAILED DESCRIPTION OF THE INVENTION

For purposes of this invention, the term “precipitated silica” is intended to encompass materials that are formed from the reaction of a metal silicate (such as sodium silicate) with an acid (such as sulfuric acid) to form an amorphous solid silica material. Typically precipitated silicas are distinguished from silica gels by their higher pH, such as greater than 6 pH, lower surface areas measured by nitrogen porosimetry typically less than 350 m²/g and larger median pore diameters above 100 Å. Such materials may be categorized as silicon dioxide, precipitated silica, hydrated silica, colloidal silicon dioxide, amorphous precipitated silica or dental grade silica. The difference between these categories lies strictly within the naming and intended use. In any event, as noted above, the term “precipitated silica” is intended to encompass any and all of these types of materials. It has been found that precipitated silicas exhibiting a resultant pH of less than about 8.0 contain a percentage of micropores of size less than 20 Å, and a median pore diameter of about 100 to 300 Å. While not wishing to be held by theory, it is believed that capture of toxic gases, such as ammonia, is accomplished by two separate (but potentially simultaneous) occurrences within the pores of the metal-doped precipitated silicas: acid-base reaction and complexation reaction. Thus precipitated silicas contain a combination of large pores for quick gas uptake and mass transport and smaller pores connected to such large pores within which metal may be deposited. Basically, it is believed, without being bound to any specific scientific theory, that such smaller pores of suitable size are available to entrap a metal, such as copper, and thus have more metal available for complexation and acid-base reactions. It is believed that the amount of a gas such as ammonia that is captured and held by the precipitated silica results from a combination of these two means. The ability to tailor the pore sizes in order to best permit metal deposition therein is thus a particularly interesting subject of the invention. The gas, such as ammonia, may enter the pores, liquefy therein, and then contact the metal species to form the needed complexes that result in ammonia capture.

Precipitated silica may be produced by reacting an alkali metal silicate and a mineral acid in an aqueous medium. When the quantity of acid reacted with the silicate is such that the final pH of the reaction mixture is alkaline, the resulting product is considered to be precipitated silica. Sulfuric acid is the most commonly used acid, although other mineral acids such as hydrochloric acid, nitric acid, or phosphoric acid may be used. Sodium or potassium silicate may be used, for example, as the alkali metal silicate. Sodium silicate is preferred because it is the least expensive and most readily available. The concentration of the aqueous acidic solution is generally from about 5 to about 70 percent by weight and the aqueous silicate solution commonly has an SiO₂ content of about 6 to about 25 weight percent and a molar ratio of SiO₂ to Na₂O of from about 1:1 to about 3.4:1.

The mineral acid is added to the metal silicate solution to form precipitated silica. Alternatively, a portion of the metal silicate is first added to a reactor to serve as the reaction medium and then the remaining metal silicate and the mineral acid are added simultaneously to the medium. Generally, continuous processing can be employed and mineral acid is metered separately into a high speed mixer. The reaction may be carried out at any convenient temperature, for example, from about 15 to about 100° C. and is generally carried out at temperatures between 60 and 90° C.

The silica will generally precipitate directly from the admixture of the reactants and is then washed with water or an aqueous acidic solution to remove residual alkali metal salts which are formed in the reaction. For example, when sulfuric acid and sodium silicate are used as the reactants, sodium sulfate is entrapped in the precipitated silica wet mass. Prior to washing, the mass may be further adjusted with additional mineral acid as is necessary to achieve the desired final pH. The mass may be washed with an aqueous solution of mineral acid such as sulfuric acid, hydrochloric acid, nitric acid, or phosphoric acid or a medium strength acid such as formic acid, acetic acid, or propionic acid.

Generally, the temperature of the wash medium is from about 27° C. to about 93° C. Preferably, the wash water is at a temperature of from about 50° C. to about 93° C. The silica wet mass is washed for a period sufficient to reduce the total salts content to less than about 5 weight percent. The mass may have, for example, a Na₂O content of from about 0.05 to about 3 weight percent and a SO₄ content of from about 0.05 to about 3 weight percent, based on the dry weight of the precipitated silica. The period of time necessary to achieve this salt removal varies with the flow rate of the wash medium and the configuration of the washing apparatus. Generally, the period of time necessary to achieve the desired salt removal is from about 0.05 to about 3 hours. Thus, it is preferred that the precipitated silica mass be washed with water at a temperature of from about 50° C. to about 93° C. for about 0.05 to about 3 hours. In one potential embodiment, the washing may be limited in order to permit a certain amount of salt (such as sodium sulfate), to be present on the surface and within the pores of the silica material. Such salt is believed, without intending on being limited to any specific scientific theory, to contribute a level of hydration that may be utilized for the subsequent metal doping procedure to effectively occur.

In order to prepare hydrous precipitated silicas suitable for use in the filter media of this invention, the final silica pH upon completion of washing as measured in 5 weight percent aqueous slurry of the silica, may range from about 6 to about 8.

The washed precipitated silica mass generally has a water content, as measured by oven drying at 105° C. for about 16 hours, of from 10 to about 60 weight percent and a particle size ranging from about 1 micron to about 50 millimeters. Alternatively the precipitated silica is then dewatered to a desired water content of from about 20 to about 90 weight percent, preferably from about 50 to about 85 weight percent. Any known dewatering method may be employed to reduce the amount of water therein or conversely increase the solids content thereof. For example, the washed precipitated silica mass may be dewatered in a filter, rotary dryer, spray dryer, tunnel dryer, flash dryer, nozzle dryer, fluid bed dryer, cascade dryer, and the like.

The average particle size referred to throughout this specification is determined in a MICROTRAC® particle size analyzer. When the water content of the precipitated silica is greater than about 20 weight percent, the precipitated silica may be pre-dried in any suitable dryer at a temperature and for a time sufficient to reduce the water content of the precipitated silica to below about 50 weight percent to facilitate handling, processing, and subsequent metal doping.

The precipitated silica particles may be ground to relatively uniform particles sizes concurrently during doping or subsequent to the doping step. One option is to subject the precipitated silica materials to high shear mixing during the metal doping procedure. In such a step, the particle sizes can be reduced to the sizes necessary for proper filter utilization. In such alternative manners, the overall production method can effectuate the desired homogeneous impregnation of the metal for the most effective noxious gas removal upon utilization as a filter medium.

Thus, in one possible embodiment, the precipitated silica is wet ground in a mill in order to provide the desired average particle size suitable for further reaction with the metal dopant and the subsequent production of sufficiently small pore sizes for the most effective ammonia gas trapping and holding while present within a filter medium. For example, the precipitated silica may be concurrently ground and dried with any standard mechanical grinding device, such as a hammer mill, as one non-limiting example. The ultimate particle sizes of the metal impregnated (doped) precipitated silica materials are dependent upon the desired manner of providing the filter medium made therefrom. Thus, packed media will require larger particle sizes (from 100 microns to 5 millimeters, for example) whereas relatively small particles sizes (from 1 to 100 microns, for example) may be utilized as extrudates within films or fibers. The important issue, however, is not the particle sizes in general, but the degree of homogeneous metal doping effectuated within the pores of the subject precipitated silicas themselves.

The hydrous precipitated silica product after grinding preferably remains in a wet state (although drying and grinding may be undertaken, either separately or simultaneously; preferably, though, the materials remain in a high water-content state for further reaction with the metal dopant) for subsequent doping with a multivalent metal salt in order to provide effective ammonia trapping and holding capability within a filter medium. The metals that can be utilized for such a purpose include, as alluded to above, any multivalent metal, such as, without limitation, cobalt, iron, manganese, zinc, aluminum, chromium, copper, tin, antimony, indium, tungsten, silver, gold, platinum, mercury, palladium, cadmium, nickel, and any combinations thereof. For cost reasons, copper and zinc are potentially preferred, with copper most preferred. The listing above indicates the metals possible for production during the doping step within the pores of the subject precipitated silica materials. The metal salt is preferably water-soluble in nature and facilitates dissociation of the metal from the anion when reacted with silica-based materials. Thus, sulfates, chlorides, bromides, iodides, nitrates, and the like, are possible as anions, with sulfate, and thus copper sulfate, most preferred as the metal doping salt (cupric chloride is also potentially preferred as a specific compound; however, the acidic nature of such a compound may mitigate against use on industrial levels). Without intending on being bound to any specific scientific theory, it is believed that copper sulfate enables doping of copper [as a copper (II) species] in some form to the precipitated silica structure, while the transferred copper species maintains its ability to complex with ammonium ions, and further permits color change within the filter medium upon exposure to sufficient amounts of ammonia gas to facilitate identification of effectiveness of gas removal and eventual saturation of the filter medium. The wet state doping procedure has proven to be critical for the provision of certain desired filter efficiency results. The wet state doping can occur when the precipitated silica remains in a wet mass or by providing the metal dopant while in solution, and thus, one alternative may include the production of a slurry of the previously dried precipitated silica material reacted with the desired metal salt. A dry mixing of the dry metal salt and precipitated silica does not accord the same degree of impregnation within the silica pores necessary for ammonia capture and retention. Without such a wet reaction, although capture may be accomplished, the ability to retain the trapped ammonia (in this situation, the ammonia may actually be modified upon capture or within the subject environment to ammonium hydroxide as well as a portion remain as ammonia gas) is drastically reduced. As in the noted Kemira reference above, a dry mix procedure produces a regenerable filter medium rather than a permanent capture and retention filter medium. The particular wet reaction is discussed more specifically within the examples below, but, in its broadest sense, the reaction entails the reaction of precipitated silica with introduced water present in an amount of at least 50% by weight of the silica and metal salt materials. Preferably, the amount of water is higher, such as at least 70%; more preferably at least 80%, and most preferably at least 85%. If the reaction is too dry, proper metal doping will not occur as the added water is necessary to transport the metal salts into the pores of the precipitated silica materials. Without sufficient amounts of metal within such pores, the gas removal capabilities of the filter medium made therefrom will be reduced. The term “added” or “introduced” water is intended to include various forms of water, such as, without limitation, water present within a solution of the metal salt, in the silica, hydrated forms of metal salts, hydrated forms of residual silica reactant salts, such as sodium sulfate, moisture, and relative humidity; basically any form that is not present as an integral part of the either the silica or metal salt itself, or that is not transferred into the pores of the material after doping has occurred. Thus, as non-limiting examples, again, the production of silica material, followed by drying initially with a subsequent wetting step (for instance, slurrying within an aqueous solution, as one non-limiting example), followed by the reaction with the multivalent metal salt, may be employed for this purpose, as well as the potentially preferred method of retaining the silica material in a wet state with subsequent multivalent metal salt reaction thereafter.

Water is also important, however, to aid in the complexation of the metal with the subject noxious gas within the silica pores. It is believed, without intending on being bound to any specific scientific theory, that upon doping the metal salt is actually complexed, via the metal cation, to the precipitated silica within the pores thereof (and some may actual complex on the silica surface but will more readily be de-complexed and thus removed over time); the complex with the metal is relatively strong and thus difficult to break. The presence of water at that point aids in removing the anionic portion of the complexed salt molecule through displacement thereof with hydrates. It is believed that these hydrates can then be displaced themselves by, as one example, the ammonia gas (or ammonium ions) thereby producing an overall silica/metal/ammonium complex that is strongly associated and very difficult to break, ultimately providing not only an effective ammonia gas capture mechanism, but also a manner of retaining such ammonia gases substantially irreversibly. The water utilized as such a complexation aid can be residual water from the metal doping step above, or present as a hydrated form on either the silica surface (or within the silica pores) or from the metal salt reactant itself. Furthermore, and in one potentially preferred embodiment, such water may be provided through the presence of humectants (such as glycerol, as one non-limiting example).

The multivalent metal doped precipitated silicas are employed in the filter medium of this invention in an amount from about 1 to about 90 percent, preferably about 5 to about 70 percent, by weight of the entire filter medium composition.

The filter medium of the invention can also further contain as optional ingredients, silicates, clays, talcs, aluminas, carbons, polymers, including but not limited to polysaccharides, gums or other substances used as binder fillers. These are conventional components of filter media, and materials suitable for this purpose need not be enumerated for they are well known to those skilled in the art. Furthermore, such metal-doped precipitated silica materials of the invention may also be introduced within a polymer composition (through impregnation, or through extrusion) to provide a polymeric film, composite, or other type of polymeric solid for utilization as a filter medium. Additionally, a nonwoven fabric may be impregnated, coated, or otherwise treated with such invention materials, or individual yarns or filaments may be extruded with such materials and formed into a nonwoven, woven, or knit web, all to provide a filter medium base as well. Additionally, the inventive filter media may be layered within a filter canister with other types of filter media present therewith (such as layers of carbon black material), or, alternatively, the filter media may be interspersed together within the same canister. Such films and/or fabrics, as noted above, may include discrete areas of filter medium, or the same type of interspersed materials (carbon black mixed on the surface, or co-extruded, as merely examples, within the same fabric or film) as well.

The filter system utilized for testing of the viability of the medium typically contains a media bed thickness of from about 1 cm to about 3 cm thickness, preferably about 1 cm to about 2 cm thickness within a flask of 4.1 cm in diameter. Without limitation, typical filters that may actually include such a filter medium, for example, for industrial and/or personal use, will comprise greater thicknesses (and thus amounts) of such a filter medium, from about 1-15 cm in thickness and approximately 10 cm in diameter, for example for personal canister filter types, up to 100 cm in thickness and 50 cm in diameter, at least, for industrial uses. Again, these are only intended to be rough approximations for such end use applications; any thickness, diameter, width, height, etc., of the bed and/or the container may be utilized in actuality, depending on the length of time the filter may be in use and the potential for gaseous contamination the target environment may exhibit. The amount of filter medium that may be introduced within a filter system in any amount, as long as the container is structurally sufficient to hold the filter medium therein and permits proper airflow in order for the filter medium to properly contact the target gases.

It is important to note that although ammonia gas is the test subject for removal by the inventive filter media discussed herein, such media may also be effective in removing other noxious gases from certain environments as well, including formaldehyde, nitrous oxide, and carbon disulfide, as merely examples.

As previously mentioned, the filter medium can be used in filtration applications in an industrial setting (such as protecting entire industrial buildings or individual workers, via masks), a military setting (such as filters for vehicles or buildings or masks for individual troops), commercial/public settings (office buildings, shopping centers, museums, governmental locations and installations, and the like). Specific examples may include, without limitation, the protection of workers in agricultural environments, such as within poultry houses, as one example, where vast quantities of ammonia gas can be generated by animal waste. Thus, large-scale filters may be utilized in such locations, or individuals may utilize personal filter apparatuses for such purposes. Furthermore, such filters may be utilized at or around transformers that may generate certain noxious gases. Generally, such inventive filter media may be included in any type of filter system that is necessary and useful for the removal of potential noxious gases in any type of environment.

### BRIEF DESCRIPTION OF THE DRAWINGS

Certain graphical representations accompany the text description of this invention. Nothing therein should be considered as limiting the scope of the invention.

FIG. 1 is a graphical representation relating to the information provided within TABLE 3, below, in terms of the concentration of ammonia uptake by the subject inventive and comparative filter media materials over time.

### PREFERRED EMBODIMENTS OF THE INVENTION

Copper content was determined utilizing an ICP-OES model Optima 3000 available from PerkinElmer Corporation, Shelton, Conn.

The % solids of the adsorbent wet cake were determined by placing a representative 2 g sample on the pan of a CEM 910700 microwave balance and drying the sample to constant weight. The weight difference is used to calculate the % solids content.

Pack or tapped density is determined by weighing 100.0 grams of product into a 250-mL plastic graduated cylinder with a flat bottom. The cylinder is closed with a rubber stopper, placed on the tap density machine and run for 15 minutes. The tap density machine is a conventional motor-gear reducer drive operating a cam at 60 rpm. The cam is cut or designed to raise and drop the cylinder a distance of 2.25 in. (5.715 cm) every second. The cylinder is held in position by guide brackets. The volume occupied by the product after tapping was recorded and pack density was calculated and expressed in g/ml.

The conductivity of the filtrate was determined utilizing an Orion Model 140 Conductivity Meter with temperature compensator by immersing the electrode epoxy conductivity cell (014010) in the recovered filtrate or filtrate stream. Measurements are typically made at a temperature of 15-20° C.

Surface area is determined by the BET nitrogen adsorption methods of Brunaur et al., J. Am. Chem. Soc., 60, 309 (1938).

Accessible porosity has been obtained using nitrogen adsorption-desorption isotherm measurements. The BJH (Barrett-Joiner-Halender) model average pore diameter was determined based on the desorption branch utilizing an Accelerated Surface Area and Porosimetry System (ASAP 2010) available from Micromeritics Instrument Corporation, Norcross, Ga. Samples were out gassed at 150-200° C. until the vacuum pressure was about 5 μm of Mercury. This is an automated volumetric analyzer at 77° K. Pore volume is obtained at pressure P/P₀=0.99. Average pore diameter is derived from pore volume and surface area assuming cylindrical pores. Pore size distribution (ΔV/ΔD) is calculated using BJH method, which gives the pore volume within a range of pore diameters. A Halsey thickness curve type was used with pore size range of 1.7 to 300.0 nm diameter, with zero fraction of pores open at both ends.

The N₂ adsorption and desorption isotherms were classified according to the 1985 IUPAC classification for general isotherm types including classification of hysteresis to describe the shape and inter connectedness of pores present in the precipitated silicas.

Adsorbent micropore area (S_{micro}) is derived from the Halsey isotherm equation used in producing a t-plot. The t-plot compares a graph of the volume of nitrogen absorbed by the adsorbent as compared with the thickness of the adsorbent layer to an ideal reference. The shape of the t-plot can be used to estimate the micropore surface area. Percent microporosity is then estimated by subtracting the external surface area from the total BET surface area, where S_{micro}=S_{BET}−Sₑₓₜ. Thus % BJH microporosity=S_{micro}/S_{BET}×100.

The level of metal impregnate is expressed on a % elemental basis. A sample impregnated with about 5 wt % of copper exhibits a level of copper chloride so that the percent Cu added to the precipitated silica is about 5 wt % of Cu/adsorbent weight. In the case of cupric chloride dihydrate, (CuCl₂.2H₂O), then 100 g of dry adsorbent would be impregnated with dry 113.65 g of cupric chloride. Thus, the calculation is basically made as % Metal=Weight of elemental metal in metal salt/(weight of dry precipitated silica+weight of total dry metal salt).

### EXAMPLES 1-5

In examples 1-5, particles of absorbent precipitated silica were produced by adding 12,865 liters of 13.3% sodium silicate solution (2.65 mole SiO₂: Na₂O) to a stirred vessel. The mixture was heated to 80° C. Next, 11.4% sulfuric acid was added at a rate of 161.2 LPM simultaneously with 15.4% aqueous aluminum sulfate solution at a rate of 11.5 LPM for 45 minutes. Then 13.3% sodium silicate was added at a rate of 301.7 LPM for 10 minutes, while maintaining the reaction mass at 80° C. Next the reaction mass was adjusted to pH 6.5 by adding 11.4% sulfuric acid at a rate of 161.2 LPM, and finally manually adjusted to pH 5.4. Thereafter, the reaction mixture was heated to 93° C. and digested for 10 minutes at this temperature. The resulting precipitated amorphous silica product was filtered and washed with water to a filtrate conductivity of 3600 μmhos, then dried using a rotary atomizer spray dryer and milled to yield a finely divided silica powder. This milled untreated base material is used as the base material to prepare Examples 1-5.

Example 1 was a control sample of granulated precipitated silica without any metal added. Examples 2-5 copper impregnated silicas were prepared by blending a known weight of base silica prepared above with a cupric chloride solution. The cupric chloride solution was first formed by mixing the specified amount of CuCl₂.2H₂O with the specified amount of water and then adding the specified amount of dry precipitated silica formed above to the cupric chloride solution in a high shear blender. The pH of the resulting mixture was adjusted with a 10% HCl solution, as indicated. Absorbent particles were prepared when the solution of cupric chloride was added with vigorous mixing in a coffee mill to achieve a homogeneous blend of silica and copper salt to provide the desired level of Cu in the final sample. The crude wet granules obtained were 200-1600 μm in size. The granular wet mass was recovered and dried in an oven for 16 hours. The dry material was sieved on a stack of 2 U.S. Standard Mesh screens size 20 mesh and 40 mesh to recover absorbent particles sized between 850 μm and 425 μm. The target particle granules obtained in this manner have a bulk density of approximately 0.4 g/ml. Process variables for copper impregnation are summarized in Table 1.

TABLE 1

| | | | | | | Drying |
|---|---|---|---|---|---|---|
| | | Water | base | | | Temp. |
| Example | CuCl₂.2H₂OG | ml | silica g | 10% HCl g | | ° C. |
| 1 | 0 | 26 | 15 | — | | 105 |
| (Control) | | | | | | |
| 2 | 2.01 | 26 | 15 | 2 | drops | 105 |
| 3 | 10.2 | 26 | 15 | — | | 60 |
| 4 | 10.2 | 21 | 15 | 5 | | 60 |

| | | | | | |
|---|---|---|---|---|---|
| 5 | 27.8 | 26 | 15 | — | 60 |

Physical properties of Example 1-5 were determined according to the methods described above and results are summarized in Table 2 below.

### EXAMPLES 6-9

To 425 liters of water, 78 liters of 13.3% sodium silicate solution (3.3 mole SiO₂: Na₂O) was added and the mixture was heated to 45° C. Next, 11.4% sulfuric acid was added at a rate of 7.15 LPM for 5 minutes, then simultaneous addition of 11.4% sulfuric acid at a rate of 7.15 LPM and 13.3% sodium silicate at a rate of 12.8 LPM began and continued for 24 minutes at 35° C. Thereafter the reaction mixture was heated to 94° C. and digested for 10 minutes at this temperature. The resulting precipitated amorphous silica product was filtered and washed with water to a filtrate conductivity of 3600 μmhos, then dried using a rotary atomizer spray dryer to recover finely divided silica powder. This control, untreated base material is designated Example 6.

Example 7 was prepared by blending, in a high shear blender, 15 g of Example 6 silica with 6.1 g CuCl₂.2H₂O and 29.6 g deionized water. The granular wet mass was recovered and dried in an oven set 60° C. at for 16 hr and sieved on a stack of 2 U.S. Standard Mesh screens size 20 mesh and 40 mesh to recover adsorbent particles sized between 850 μm and 425 μm. The resultant material exhibited 8.36% by weight of copper therein.

Example 8 was prepared by blending 15 g of Example 6 silica with 10.2 g CuCl₂.2H₂0 and 29.6 g deionized water, in a high shear blender. The granular wet mass was recovered and dried in an oven set 60° C. at for 16 hr and sieved as described above to recover adsorbent particles sized between 850 μm and 425 μm. The resultant material exhibited 12.34% by weight of copper therein.

Example 9 was prepared by blending 15 g of Example 6 silica with 18.0 g CuCl₂.2H₂0 and 29.6 g deionized water in a high shear blender. The granular wet mass was recovered and dried in an oven set at 60° C. for 16 hours and sieved as described above to recover adsorbent particles sized between 850 μm and 425 μm. The resultant material exhibited 15.34% by weight of copper therein. Physical properties of Examples 6-9 were determined according to the methods described above and results are summarized in Table 2 below.

### EXAMPLE 10

Examples 10 was impregnated with copper by adding 150 g of dry precipitated silica base material of Example 1 and a copper sulfate solution formed by mixing 215 g CuSO₄.5H₂O with 612 g of water to a CUISINART® model DFP14BW Type 33 high shear mixer/agitator. The wet mass was agitated until homogenous and then placed directly in an oven set at 105° C. without filtration and dried overnight (16 hr) and re-milled to a homogenous powder. This material is designated as Example 10A.

Next, 280 g of Example 10A was added back into a CUISINART high shear mixer/agitator and agitation began. To this agitated silica was added 329 g deionized water. The formed granules were collected and dried at 105° C. for 16 hours and are designated Example 10B. Physical properties of Example 10A and Example 10B were determined according to the methods described above and results are summarized in Table 2 below.

### EXAMPLE 11

Example 11 was impregnated with copper by adding 150 g of dry precipitated silica base material of Example 1 and a copper sulfate solution formed by mixing 172 g CuSO₄.5H₂O with 600 g of water to a CUISINART model DFP14BW Type 33 high shear mixer/agitator. The wet mass was agitated until homogenous and then placed directly in an oven set at 105° C. without filtration and dried overnight (16 hr) and re-milled to a homogenous powder. This material is designated as Example 11A.

Next, 260 g of Example 11A was added back into a CUISINART high shear mixer/agitator and agitation began. To this agitated silica was added 270 g deionized water. The formed granules were collected and dried at 105° C. for 16 hours and are designated Example 11B. Physical properties of Example 11A and Example 11B were determined according to the methods described above and results are summarized in Table 2 below.

### EXAMPLE 12

Copper impregnated silica granules were prepared by adding 3000 g of the base material of Example 1 to a container equipped with a Lightnin mixer. Next, 12,240 g of deionized water and 4300 g CuSO₄.5H₂O was added. The mixture was agitated as fast as possible without the contents splashing out of the container for 30 minutes. The resultant product was collected and dried for 16 hr at 105° C. To form granules and increase product density, 1 kg of the dried particles prepared above were compacted in a roller compactor (model WP50N/75 available from Alexanderwerks GmbH, Germany) using a pressing force 50 bar to form crayon-shaped agglomerates, which were then comminuted in a grinding process, pre-grinding using toothed-disk rollers (Alexanderwerks). The crude granules obtained were approximately 0.7 kg of 400-1600 μm sized granules. The granules were then sized by sieving as described above to recover granules sized between 850 μm and 425 μm. Finally, the granules were re-hydrated by placing them in a controlled temperature/humidity chamber set to 36° C. and 50% RH for 18 hours. Physical properties of Example 12 were determined according to the methods described above and results are summarized in Table 2 below.

### EXAMPLE 13

Example 13 was prepared by blending in a high shear Cowles blender, 7530 g of Example 6 silica wet cake (filtered to 15% solids, but not dried) at 6000 RPM until homogenous. To this was added 1640 g of dry CuSO₄.5H₂O crystals. Water was added just until a fluid slurry was produced and the agitation speed was then reduced to 4000 RPM. The silica-cupric sulfate mixture was vigorously mixed at 4000 RPM for 30 minutes to achieve a homogeneous blend of silica and copper salt to provide a resultant material exhibit 15% by weight of copper in the final sample. The wet mass was recovered and dried in an oven set at 125° C. for 40 hours.

To form granules and increase product density, 1 kg of the dried particles prepared above and having a bulk density of about 0.50 g/ml were compacted in a roller compactor (model WP50N/75 available from Alexanderwerks GmbH, Germany) using a pressing force of 200-500 kP (40-70 bar) to form crayon-shaped agglomerates, which were then comminuted in a grinding process, pre-grinding using toothed-disk rollers (Alexanderwerks). The crude granules obtained were approximately 0.7 kg of 400-1600 μm sized granules. The granules were then sized by sieving as described above to recover granules sized between 850 μm and 425 μm. The target particle granules obtained in this manner have a bulk density of approximately 0.7 g/cc. Physical properties of Example 13 were determined according to the methods described above and results are summarized in Table 2 below.

### COMPARATIVE EXAMPLE 1

Particles of commercially available Silica Gel 408 Type RD desiccant grade silica gel available from W.R. Grace & Company, Columbia, Md., were sized by sieving as previously described above to recover particles sized between 850 μm and 425 μm. Physical properties of Comparative Example 1 were determined according to the methods described above and results are summarized below in Table 2.

### COMPARATIVE EXAMPLE 2

Particles of the commercial precipitated silica, ZEOSYL® 177 (J. M. Huber Corporation) were mixed with copper by dry mixing together 200 g of Comparative Example 1 particles and 450 g of dry milled copper sulfate, CuSO₄.5H₂O (no water was introduced other than that present in hydrated form and as provided by humidity of the reactor). The resultant copper treated particles were deagglomerated and roller compacted at 50 bar before being sized by sieving as described above to recover particles sized between 850 μm and 425 μm. Comparative Example 2 contained 15% Cu. Physical properties of Comparative Example 2 were determined according to the methods described above and results are summarized below in Table 2.

### COMPARATIVE EXAMPLE 3

Particles of commercially available ASZM-TEDA Impregnated carbon particles available from Calgon Corporation, Pittsburgh, Pa., were sized by sieving as described above to recover granules sized between 850 μm and 425 μm. Physical properties of Comparative Example 3 were determined according to the methods described above and results are summarized below in Table 2.

TABLE 2

| | | Packed | Surface | | | Total Pore | |
|---|---|---|---|---|---|---|---|
| Example | | Density, | Area | % BJH | | Volume | |
| No. | % Cu | g/ml | m2/g | Microporsity | Hysteresis | cc/g | MPD (Å) |
| 1 | 0 | 0.47 | 98 | 27.8 | IV-H₁ | 0.34 | 145 |
| 3 | 12.3 | 0.49 | 85 | 34.6 | IV-H₁ | 0.51 | 252 |
| 4 | 14.8 | 0.37 | 89 | 28.3 | IV-H₁ | 0.49 | 227 |
| 5 | 23.6 | 0.59 | 50 | 28 | IV-H₁ | 0.30 | 243 |
| 6 | 0 | | 334 | 20.7 | IV-H₁ | 1.60 | 183 |
| 7 | 8.36 | — | 180 | 18.7 | IV-H₁ | 0.85 | 163 |
| 8 | 12.34 | — | 152 | 21.1 | IV-H₁ | 0.79 | 185 |
| 9 | 15.34 | — | 128 | 10.8 | IV-H₁ | 0.64 | 164 |
| 11B | 16.36 | 0.44 | 83 | 37.3 | IV-H₁ | 0.38 | 212 |
| 12 | 15 | 0.78 | 70 | 22.3 | IV-H₁ | 0.41 | 212 |
| Comparative | 0 | 0.73 | 755 | 71.0 | IV-H₂ | 0.24 | 27 |
| Example 1 | | | | | | | |
| Comparative | 15 | 0.77 | 361 | — | IV-H₄ | 0.163 | 33 |
| Example 2 | | | | | | | |
| Comparative | 0 | 0.60 | 790 | 89 | I-H₄ | 0.159 | 35 |
| Example 3 | | | | | | | |

Several of the examples prepared above were evaluated for their capacity to absorb ammonia from air, both in terms of uptake and breakthrough. Uptake measurements provide evidence of the effectiveness of the adsorbent filter medium to remove and capture noxious gases, in this situation, as a test subject, ammonia gas, from within the test system in a certain period of time. Breakthrough measures the amount of time such a filter medium becomes saturated. A combination of high uptake with long breakthrough is thus the target for a suitable filter medium.

For the ammonia uptake tests, the following protocol was followed, basically in accordance with that set forth within Mahle, J., Buettner, L. and Friday, D. K., “Measurement and Correlation of the Adsorption Equilibria of Refrigerant Vapors on Activated Carbon,” Ind. Eng. Chem. Res., 33, 346-354 (1994). The precipitated silica adsorbent samples were loaded into a 15 μm frit-bottomed metal cell that allows airflow of a constant volume to be recycled through the cell in a closed loop system. The bed height of the filter medium was recorded after adding 100 mg of adsorbent (filter medium). The system is typically dry but the relative humidity of the system may be adjusted (Humid) by injecting a known quantity of water into the system to increase the relative humidity. The target ammonia concentration was 1100 mg/m³ in the closed loop system, which was equilibrated at 25° C., and the actual concentration of ammonia in the airstream was monitored using an infrared analyzer (MIRAN, Foxboro Company, Foxboro, Mass.). Ammonia was injected into the system through a septum located at the inlet (low pressure side) of the circulating pump.

The batch uptake test started with the adsorbent bed in the bypass mode. Ammonia was injected into the system and allowed to equilibrate. The mass of ammonia injected was determined by the volume of the gas-tight syringe. The infrared analysis was initially a redundant determination of the NH₃ mass injected. After the ammonia concentration stabilized, the bed bypass valve was changed to send the ammonia-contaminated air over the adsorbent (filter medium). The infrared analyzer then measured the gas-phase concentration change as a function of time.

A decrease in concentration outside the filter bed was an indication of ammonia removal from the air stream by the adsorbent. Precisely known weights of the subject gases allowed ammonia uptake to be measured, as well. The system temperature was increased from 25 to 75° C. after 100 minutes to determine if the ammonia captured up to that time was on the surface of the precipitated silica materials or within the pores (an increase in the concentration measurement within the headspace of the system indicated a release of ammonia from the filter medium). A release of ammonia from the silica materials noticed upon such a temperature increase was an indication that the capture of such gas occurred at the silica material surface since any captured within the pores by the metal complex would not be readily released from such a relatively low temperature increase.

To compare the performance of various samples using uptake data, the concentration of ammonia at various key time points was measured. To assess the ability of the precipitated silicas of this invention to remove ammonia quickly, the uptake concentrations in mg/m³ of ammonia absorbed before and after elevating the bed temperature from 25° C. to 75° C. once the ammonia concentration was approximately stabilized. Tests were performed at humid conditions to show the enhanced performance of the inventive precipitated silica adsorbents of this invention.

A reduction in ammonia concentration to less than 400 mg/m³ at 25° C. was targeted to show effectiveness in ammonia removal.

TABLE 3
Ammonia Uptake Rate

| | | | Conc, | | |
|---|---|---|---|---|---|
| | | Conc, | mg | | |
| | | mg | NH₃/ | | |
| | Initial | NH₃/m³ | m³ | Conc, | Conc, |
| | Conc., mg | at 1 | at 5 | mg NH₃/m³ | mg NH₃/m³ |
| Example No. | NH₃/m³ | minute | minute | at 15 minute | at 60 minute |
| Comparative | 1100 | 1067 | 981 | 867 | 687 |
| Example 1 | | | | | |
| Example 1 | 1100 | 868 | 633 | 550 | 523 |
| Example 4 | 1100 | 914 | 662 | 578 | 481 |
| Example 5 | 1100 | 927 | 780 | 717 | 640 |

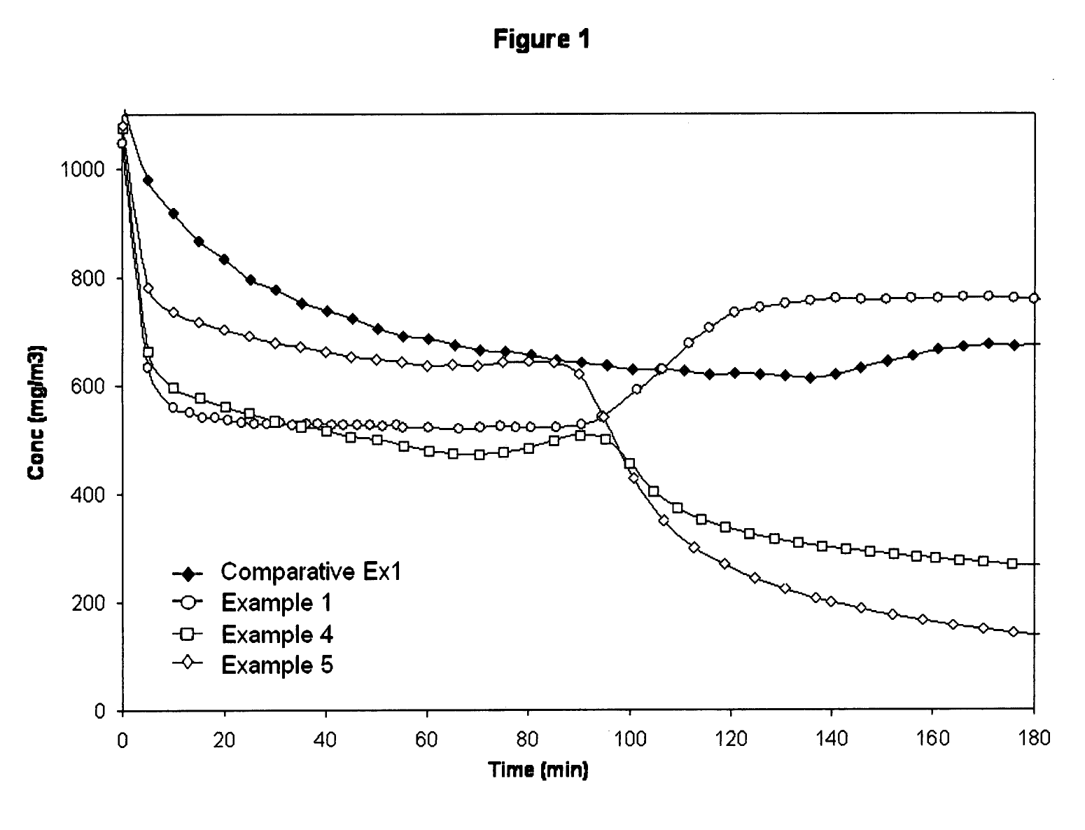

Since the uptake system is volumetric the amount of chemical in the vapor is inversely proportional to amount of chemical adsorbed and/or reacted on the adsorbent. Table 3 and FIG. 1 summarize ammonia uptake profiles for four adsorbents: two impregnated adsorbents and two unimpregnated adsorbents. The plot shows the effect of temperature; more precisely it shows that the impregnated samples can irreversibly or nearly irreversibly remove ammonia. The plot also shows the initial uptake rate of ammonia for each adsorbent. These data reveal whether a given adsorbent has an internal mass transfer rate that is fast enough to be useful in a filter at reasonable velocities. That is, even though a given adsorbent may remove a large amount of ammonia, if it takes along time to reach equilibrium that adsorbent will likely not be useful in a fielded filter. The table is limited to the first 60 minutes of measurement time, while the FIGURE represents an extension of that time to 180 minutes in order to indicate the long-term effects provided by the sample filter media.

The plot shows the effect of temperature on the adsorption behavior of ammonia for each sample. These data clearly show the presence of chemical reaction. Consider Comparative Example 1 data. At about 135 minutes the temperature of the adsorbent is changed to 75° C. The result is that the ammonia vapor phase concentration increases from about 630 mg/m³ to about 670 mg/m³. This results because adsorption equilibrium tells us that less ammonia will adsorb at higher temperatures. The difference in ammonia concentration is directly proportional to the amount of ammonia desorbed. After about 140 minutes the ammonia concentration stabilizes and no significant change is observed beyond that point. This is a perfect example of what one expects to see for reversible adsorption equilibria. The same behavior is observed with the unimpregnated precipitated silica of Example 1. Upon increasing the temperature to 75° C., the ammonia concentration is observed to increase from 522 to 757 mg/m³. The two impregnated samples on the other hand do not show the classic adsorption equilibria behavior at 75° C. For Example 4, when the temperature is raised to 75° C. at about 68 minutes, the ammonia concentration rises due to some adsorbed ammonia being displaced from the surface. But the maximum concentration increase achieved at about 90 minutes is only about ½ of the concentration increase observed for Comparative Example 1. Even though there is more ammonia associated with the adsorbent, less ammonia is being displaced during the temperature change. In addition, starting at about 95 minutes the concentration begins to decrease to a concentration of 268 mg/m³ at 180 minutes. This is clearly evidence of chemical reaction. For Example 5 at a higher impregnant level, the irreversibility is even more dramatic. At about 68 minutes the temperature was changed to 75° C. and the ammonia concentration rises due to some adsorbed ammonia being displaced from the surface and then falls to a concentration of 140 mg/m³ at 180 minutes.

Further, comparing the initial uptake rate of each adsorbent is a good method to establish the usefulness of the media in an operating filter. Comparative Example 1 is a known adsorbent that is used in a many industrial filter systems. If the initial uptake rate of the proposed adsorbents is faster than that of Comparative Example 1, we can be assured that from a mass transfer perspective, the given adsorbent can function properly in an industrial filter. The initial uptake rate of both of the impregnated samples is dramatically faster than that of Comparative Example 1 for about the first 15 minutes. After 20 minutes, the rate for Examples 4 and 5 slows down although the concentration remains below that of Comparative Example 1. Throughout the first 80 minutes, the amount of ammonia removed by the Examples 4 and 5 is greater than the amount of ammonia removed by the unimpregnated silicas of Comparative Example 1 and control Example 1. These data show that both the Example 4 and Example 5 materials of the present invention would be advantageous for use based on mass transfer rate.

The general protocol utilized for breakthrough measurements involved the use of two parallel flow systems having two distinct valves leading to two distinct adsorbent beds (including the filter medium), connected to two different infrared detectors, followed by two mass flow controllers. The overall system basically permitting mixing of ammonia and air within the same pipeline for transfer to either adsorbent bed or continuing through to the same gas chromatograph. In such a manner, the performance of the filter media within the two adsorbent beds was compared for ammonia concentration after a certain period of time through the analysis via the gas chromatograph as compared with the non-filtered ammonia/air mixture produced simultaneously. A vacuum was utilized at the end of the system to force the ammonia/air mixture through the two parallel flow systems as well as the non-filtered pipeline with the flow controlled using 0-50 SLPM mass flow controllers.

To generate the ammonia/air mixture, two mass flow controllers generated challenge concentration of ammonia, one being a challenge air mass flow controller having a 0-100 SLPM range and the other being an ammonia mass flow controller having a 0-100 sccm range. A third air flow controller, was used to control the flow through a heated water sparger to control the challenge air relative humidity (RH). Two dew point analyzers, one located in the challenge air line above the beds and the other measuring the effluent RH coming out of one of the two filter beds, were utilized to determine the RH thereof (modified for different levels).

The beds were 4.1 cm glass tubes with a baffled screen to hold the adsorbent. The adsorbent was introduced into the glass tube using a fill tower to obtain the best and most uniform packing each time. The challenge chemical concentration was then measured using an HP 5890 gas chromatograph with a Thermal conductivity Detector (TCD). The effluent concentration of ammonia was measured using an infrared analyzer (MIRAN), previously calibrated at a specific wavelength for ammonia.

The adsorbent was prepared for testing by screening all of the particles below 40 mesh. The largest particles were typically no larger than about 25 mesh.

The valves above the two beds were initially closed. The diluent air flow and the water sparger air flow were started and the system was allowed to equilibrate at the desired temperature and RH. The valves above the beds were then changed and simultaneously the chemical flow was started and kept at a rate of 4.75 SLPM. The chemical flow was set to achieve the desired challenge chemical concentration. The feed chemical concentration was constantly monitored using the GC. The effluent concentrations from the two adsorbent beds (filter media) were measured continuously using the previously calibrated infrared detectors. The breakthrough time was defined as the time when the effluent chemical concentration equaled the target breakthrough concentration. For ammonia tests, the challenge concentration was 1,000 mg/m³ at 25° C. and the breakthrough concentration was 35 mg/m³ at 25° C.

Ammonia breakthrough was then measured for distinct filter medium samples, with the bed depth of such samples modified as noted, the relative humidity adjusted, and the flow units of the ammonia gas changed to determine the effectiveness of the filter medium under different conditions. A breakthrough time in excess of 60 minutes was targeted. The results are provided in Table 4.

TABLE 4
Ammonia Breakthrough

| | | Bed Depth | Breakthrough | |
|---|---|---|---|---|
| Example No. | Test % RH | Cm | Time, Min. | g/l NH₃ |
| 3 | 80 | 1.5 | 160 | 49.9 |
| 10B | 80 | 2.0 | 105 | 20.1 |
| 11B | 40 | 2.0 | 235 | 46.1 |
| 12 | 15 | 1.0 | 52 | 20.1 |
| 12 | 30 | 1.0 | 60 | 26.5 |
| 12 | 50 | 1.0 | 84 | 39 |
| 12 | 70 | 1.0 | 151 | 59.5 |
| 13 | 30 | 1.0 | 74 | 28.8 |
| Comparative | 15 | 1.0 | 34 | 12.1 |
| Example 1 | | | | |
| Comparative | 80 | 1.0 | 27 | 11.4 |
| Example 1 | | | | |
| Comparative | 15 | 1.0 | 13.9 | 4.2 |
| Example 2 | | | | |
| Comparative | 15 | 1.0 | 20 | 7.2 |
| Example 3 | | | | |

The inventive products clearly provided extremely high breakthrough levels, and particularly exceeded the 50 minute threshold by wide margins, showing the unexpectedly good results for such materials. The inventive materials demonstrate a higher breakthrough time at similar relative humidity as compared to the Comparative Examples. Example 12 was tested under the same conditions except the relative humidity was to 70%. In Table 4 above, it is seen that the inventive copper impregnated silica had a high ammonia capacity and that breakthrough times increased as the relative humidity increased.

While the invention will be described and disclosed in connection with certain preferred embodiments and practices, it is in no way intended to limit the invention to those specific embodiments, rather it is intended to cover equivalent structures structural equivalents and all alternative embodiments and modifications as may be defined by the scope of the appended claims and equivalence thereto.

What we claim is:

1. A filter medium comprising multivalent metal-doped precipitated silica materials, wherein said materials exhibit a BET surface area of between about 30 and 350 m²/g; a pore volume of greater than 0.25 cc/g to 2.0 cc/g as measured by nitrogen porosimetry; a mean pore diameter of greater than about 100 to 300 Å; and wherein the multivalent metal doped on and within said precipitated silica materials is present in an amount of from 5 to 25% by weight of the total amount of the precipitated silica materials.

2. The filter medium of claim 1 wherein said multivalent metal is present in an amount of from about 8 to about 20%.

3. The filter medium of claim 1 wherein said multivalent metal is selected from the group consisting of cobalt, iron, manganese, zinc, aluminum, chromium, copper, tin, antimony, tungsten, indium, silver, gold, platinum, mercury, palladium, cadmium, nickel, and any combinations thereof.

4. The filter medium of claim 3 wherein said multivalent metal is copper.

5. A filter system comprising the filter medium as defined in claim 1.

6. A filter system comprising the filter medium as defined in claim 2.

7. A filter system comprising the filter medium as defined in claim 3.

8. A filter system comprising the filter medium as defined in claim 4.

9. A method of producing metal-doped precipitated silica particles comprising the sequential steps of:
a) providing a precipitated silica material;
b) wet reacting said precipitated silica material with at least one multivalent metal salt to produce metal-doped precipitated silica material; and
c) drying said multivalent metal-doped precipitated silica materials.

10. The method of claim 9 wherein said multivalent metal salt is a salt having a metal selected from the group consisting of cobalt, iron, manganese, zinc, aluminum, chromium, copper, tin, antimony, indium, tungsten, silver, gold, platinum, mercury, palladium, cadmium, nickel, and any combinations thereof.

11. The method of claim 10 wherein said multivalent metal is copper.
